(19) United States
(12) Patent Application Publication
(10) Pub. No.: US 2014/0203142 A1
(43) Pub. Date: Jul. 24, 2014

(54) Refractive Body Panels (Vehicle Refractive Panels)

(71) Applicant: Marc Anthony Travalini, Wilmington, DE (US)

(72) Inventor: Marc Anthony Travalini, Wilmington, DE (US)

(21) Appl. No.: 14/161,575

(22) Filed: Jan. 22, 2014

Related U.S. Application Data
(60) Provisional application No. 61/849,140, filed on Jan. 22, 2013.

(51) Int. Cl. B64C 1/12; B63B 5/24; B62D 29/04

(52) U.S. Cl. CPC B64C 1/12; B62D 29/043; B63B 5/24
USPC 244/119; 296/181.2; 114/357

(57) ABSTRACT

Refractive body panels replace traditional metal or fiberglass panels and consist primarily of dyed and moldable plastic in a prism configuration under clear polycarbonate; a bi-layer unit working in concert to scatter and/or change the direction of light to illuminate the exterior and increase safety and performance; the bi-layer unit works together to reduce the weight of a vehicle; the dyed prism allows for panels in various colors: the panels attach to a vehicle's frame as a direct pre-market or post-market replacement (including polyurethane bumpers) and require minimal modifications to the structural design of foot-powered vehicles, motorcycles, cars, trucks, boats, etc.

### BACKGROUND

The automotive industry's move to use fiberglass body panels to reduce weight and improve speed, safety, and utility reflects a willingness to rethink the contribution of body panels to a vehicle overall value. Refractive Body Panels scatter and/or change the direction of light providing a wide-range of vehicles with greater visibility and safety, decreased weigh and increased fuel mileage, lower maintenance and no rust.

### BRIEF SUMMARY

Refractive Body Panels consist primarily of moldable plastic in a prism configuration under clear polycarbonate; a bi-layer unit working in concert to scatter and/or change the direction of light to illuminate the exterior of a car and increase visibility, safety, and fuel mileage; decrease weight, maintenance costs, and rust. The panels are applicable to all vehicles from foot-powered vehicles to cars, motorcycles, trucks, boats, etc.

### DETAILED DESCRIPTION

These body panels depend on a bi-layer unit consisting primarily of a moldable plastic in a prism configuration under polycarbonate plastic (as shown in views, FIG. 1 and FIG. 2). The panels scatter and/or change the direction of light, thereby increasing a vehicle's presence, safety, and performance. The panels attach to a vehicle's frame as a pre-market or a post-market replacement (including polyurethane bumpers) and require minimal modifications to the overall structural design of a vehicle. The bi-layer unit illuminates the exterior and improves visibility over painted panels. The polycarbonate covering is stronger than the current industrial standard; therefore, it reduces vibration, dents, scratches, and cracks.

### BRIEF DESCRIPTION OF THE VIEWS OF THE DRAWING

FIG. 1 Vehicle with view of Refractive Body Panel

FIG. 2 Cutout of a Refractive Body panel referencing front, side, and rear of vehicle.

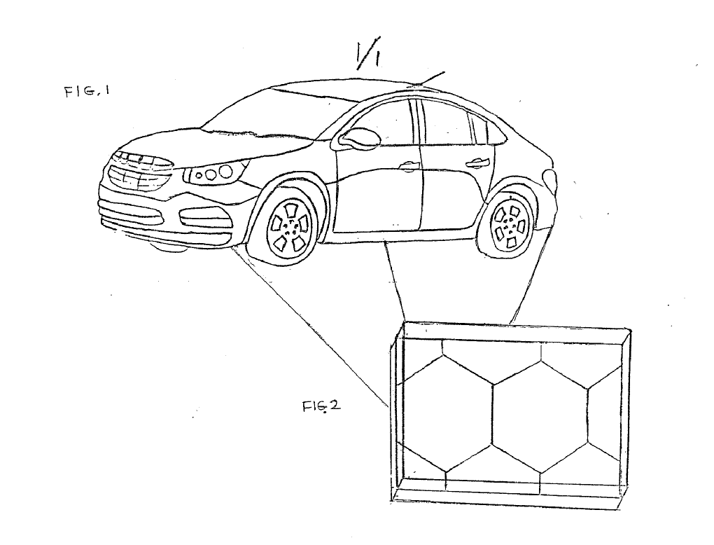

1. Refractive body panels consist primarily of moldable plastic in a prism configuration under clear polycarbonate; a bi-layer unit that works in concert to scatter and/or change the direction of light to illuminate the exterior and increase a vehicle's presence, safety, and performance; the bi-layer unit reduces overall weight and includes, the dyed prism allows for panels in various colors: the panels attach to a vehicle's frame as a direct pre-market option or post-market replacement (including polyurethane bumpers) and requires minimal modifications to the structural design of foot-powered vehicles, motorcycles, cars, trucks, boats, etc.
